(19) United States
(12) Patent Application Publication
(10) Pub. No.: US 2003/0165649 A1
(43) Pub. Date: Sep. 4, 2003

(54) Repository disposal container

(76) Inventors: Morris Reich, Kew Gardens Hills, NY (US); Bernard Manowitz, Brightwaters, NY (US); James R. Powell, Shoreham, NY (US)

Correspondence Address: LOUIS VENTRE, JR, 2483 OAKTON HILLS DRIVE, OAKTON, VA, 22124-1530, US

(21) Appl. No.: 09/875,210

(22) Filed: Jun. 6, 2001

(51) Int. Cl. B32B 1/08; B32B 1/02

(52) U.S. Cl. 428/36.91; 428/35.8; 428/34.1; 428/36.9

(57) ABSTRACT

The Repository Disposal Container is a vessel for the disposal of waste in a geologic repository. The vessel, typically a cylinder, must be made of graphite and may also be made of other materials. The graphite must be in a solid form of sufficient strength and durability to survive emplacement in the repository and form a barrier against the release of the waste into a geologic repository for a period of time in excess of that achievable from comparable vessels made of steel or any of its alloys.

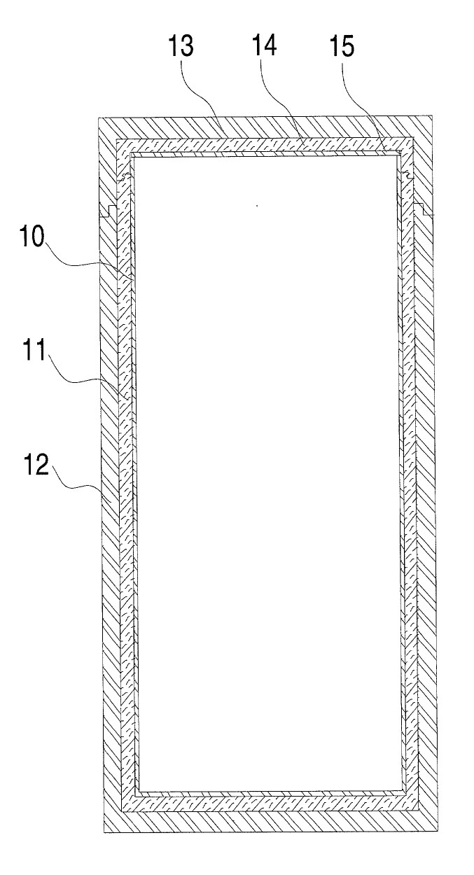

### BACKGROUND OF THE INVENTION

The Repository Disposal Container is a man-made vessel used to contain wastes in a geologic disposal site. These wastes typically include uncanistered spent nuclear fuel, canistered spent nuclear fuel, canistered high-level radioactive waste, plutonium contaminated wastes, and other wastes from both commercial and government sources (hereinafter “wastes”). Generally, a repository disposal container is what is known in art as an integral part of the waste package subsystem for a geologic repository disposal system.

Existing disposal container technology consists of a cylindrical vessel made of various forms of steel. The size of this vessel can vary in diameter from about 120 to 220 centimeters, and in outer length from about 500 to 600 centimeters. The current design of the disposal container has a 2-centimeter thick corrosion resistant outer barrier made of Alloy 22 and a 5-centimeter thick inner barrier of stainless steel. Alloy 22 is a steel alloy described by the American Society for Testing and Materials by the designation ASTM B575 N06022

Seven currently specified requirements for the waste package subsystem are—

1. Resistance to mechanical damage, i.e., rock falls, seismic events, drops;

2. Corrosion resistance to environmental liquids for periods of 10,000 years or more;

3. Criticality protection;

4. Radiation levels maintained within the limits specified in by the government (10 CFR 20);

5. A waste package maximum mass limited to 83,000 Kilograms;

6. A surface finish suitable for ease of decontamination.

7. The waste package design must include consideration of the following factors:

Solubility, oxidation production reactions, gas generation, thermal effects, radiolysis, radionuclide retardation, leaching, fire and explosion hazards, thermal loads and synergistic interactions.

The Repository Disposal Container is an improvement on disposal containers currently planned, namely, those made of stainless steel and Alloy 22. Currently, no disposal container meets the above requirements for the waste package subsystem by itself. The Repository Disposal Container is expected to meet the waste package subsystem requirements without supplementation, or with minimal supplementation. The use of a graphite barrier alone or in addition to one or more other material barriers is the improvement, which is expected to significantly enhance the disposal container's environmental performance in geologic repository.

The Repository Disposal Container is expected to be cost competitive with current designs, the expected longevity of containment integrity provided by graphite far exceeds that available with current technology, and environmental performance is greatly enhanced due to the absence of elements that are potentially harmful to the humans and the biosphere after the onset of other barrier (i.e., non-graphite) corrosion.

### BRIEF SUMMARY OF THE INVENTION

The Repository Disposal Container is a vessel for the disposal of waste in a geologic repository. The vessel, typically a cylinder, must be made of graphite and may also be made of other materials. The graphite must be in a solid form of sufficient strength and durability to survive emplacement in the repository and form a barrier against the release of the waste into a geologic repository for a period of time in excess of that achievable from comparable vessels made of steel or any of its alloys.

### BRIEF DESCRIPTION OF THE DRAWINGS

The drawing illustrates a Repository Disposal Container having an outer barrier of carbon steel (12), an inner barrier of graphite (11) and an inner barrier of carbon steel (10) within the graphite inner barrier. Wastes are loaded through the top. The top of the vessel can be sealed with separate lids for the inner steel barrier (15), the inner graphite barrier (14), and the outer steel barrier (13).

### DETAILED DESCRIPTION OF THE INVENTION

The Repository Disposal Container is a vessel for the disposal of waste in a geologic repository. The vessel must be made of graphite and may also be made of other materials. The graphite must be in a solid form of a size and thickness providing sufficient strength and durability to survive emplacement in the repository and to serve as a containment barrier preventing the release of the waste within the vessel into the geologic repository for a period of time in excess of that achievable from comparable vessels made of steel or any steel alloy. Graphite and its analogs (anthracite coal) are known to be corrosion resistant in a variety of environmental waters for millions of years.

The Repository Disposal Container may have any regular or irregular cross-sectional shape, including, but not limited to, circular, square, rectangular, or oval. The best mode for the Repository Disposal Container is a cylindrical vessel with a circular cross section.

The Repository Disposal Container must be open at one end to permit the loading of wastes. It may also be open at both ends to ease loading the waste. Typically, the vessel would be open at one end and closed at the other end. Any open end of the graphite barrier must be sealable with a graphite lid after loading the vessel with wastes.

The Repository Disposal Container can have any length (internal depth), suitable or the waste it is to contain. However, such length is constrained in that the graphite must meet the size and durability requirements stated above. Typically, such length could be between about 0.1 and 1,000 centimeters. The graphite can have any cross-sectional diameter or width measurement suitable for the waste it is to contain. Again, however, such diameter or width is constrained in that the graphite must meet the size and durability requirements stated above. Typically, the graphite vessel would have a diameter or width between about 0.1 and 1,000 centimeters. The graphite can have any wall thickness suitable for the waste it is to contain. Again, however, such wall thickness is constrained in that the graphite must meet the size and durability requirements stated above. Typically, the graphite would have a wall thickness between about 0.1 to 300 centimeters.

Typically, the graphite inner barrier would be made from high purity, reactor grade graphite. High purity, reactor grade graphite is the grade most resistant to oxidation. Oxidation of graphite varies considerably depending on the amount and nature of impurities, the extent of the BET surface area (“BET surface area” is a term of art named after Brunauer, Emmett & Teller who developed the equation used to find specific surface area), the temperature of exposure and the velocity of fluids in contact with the exposed surface.

One significant property of reactor grade graphite is that no perceptible oxidation rate has ever been measured below 500 degrees centigrade even under irradiation conditions. For the best mode of the invention, the maximum attainable temperature of the Repository Disposal Container is below 500 degrees centigrade.

For the best mode of the invention, the maximum temperature is determined by making a heat load calculation based upon fixing the maximum heat load for the Repository Disposal Container at the same heat load used for the current container design. Therefore, it is assumed that there is a maximum heat load of 1800 watts per Repository Disposal Container. This heat load would yield a maximum graphite temperature at the time of arrival at the geologic repository of about 130 degrees centigrade above ambient repository drift temperature. It is well known art that a nuclear waste geologic repository drift wall can be nominally expected to attain a maximum temperature of about 200 degrees centigrade, so that the maximum graphite temperature would be 330 degrees centigrade. Since the primary heat generating nuclides are Strontium-90 and Cesium-137, the heat load will decay with a 30-year half-life and the maximum temperature will decline significantly over that period.

In the best mode of the invention, no oxidation can take place before the outer barrier of 10 centimeters of steel is breached. This is highly unlikely for the first 30 years. Even if the outer barrier were breached and some graphite were exposed, oxidation of the graphite barrier would be minimal. In order for any greater oxidation, there would have to be air flow against the surface as reaction products in stagnant air would slow down the oxidation rate.

Typically, the graphite barrier would contain boron to absorb neutron radiation. Typically the boron would be added as boron carbide. For radioactive wastes, the peak dose rate on the surface of the vessel would be maintained within the limits of government regulations (10 CFR 20).

It is well known in the art that graphite suffers little radiation damage in dimensional and property changes from neutrons at the levels expected for nuclear waste. It is also well known in the art that graphite contains a significant number of free conduction electrons. Because of these free conduction electrons, the radiation effects produced in graphite are in many respects similar to those produced in metals.

For the best mode of the invention, the peak surface dose rate of the disposal container would be equal to or lower than what is available in the current disposal container technology. Within the scope of the invention, the peak surface dose rate of the Repository Disposal Container can be lowered to any desired level by varying the neutron absorption properties the graphite and any other barriers. Typically, this can be accomplished by setting the thickness of the barriers to provide the desired level of protection, and by using an emplacement transport shield as is done in existing disposal container designs. In variations of the invention, boron content may vary to yield larger or smaller neutron absorbing cross sections as may be appropriate to the criticality protection sought. Within the scope of the invention, neutron-absorbing materials other than boron may be added to any inner or outer non-graphite barriers.

One of the inherent characteristics of the Repository Disposal Container is that the potential for hydriding of graphite is negligible. The potential for any hydrogen to be available for reaction with the graphite is extremely small. Potential sources of hydrogen are from the radiolysis of water, and from within the graphite. Regarding the latter, it is possible for a carbon/water reaction during graphitization to produce hydrogen, which can be absorbed in the graphite. Nevertheless, even if hydrogen is available and the outer barrier is breached, it is well known that the rate of reaction of hydrogen with graphite at temperatures below 500 degrees centigrade is extremely slow.

Typically, the graphite barrier in the Repository Disposal Container would be out-gassed at high temperature and cooled under vacuum and then impregnated by the thermal decomposition of hydrocarbon gases in the pores. This method is similar to that used in forming pyrolytic carbon coatings. Multiple impregnations can reduce the permeability by a factor of one million. Such treatment will eliminate out gassing and render the graphite impermeable to water even at water pressures as high as 150 pounds per square inch.

Impermeable graphite will, therefore, provide retardation to radionuclide transport as well as leach resistance to environmental fluids.

Typically, the graphite barrier would provide the means to minimize fire and explosion hazards. Even in the total absence of steel, it is well known in the art that the potential for graphite burning under the anticipated conditions in a repository are negligible. For the best mode of the invention, the graphite is encased in 516 carbon steel, which provides higher confidence that the graphite burning potential would be extremely small even in the unanticipated presence of needed geometry, high temperatures and air flow rates necessary to make graphite burn.

Graphite can be made with considerable thermal shock resistance and abrasion resistance and alone can meet the size and durability requirements for the vessel stated above. A graphite inner barrier would have exceptional thermal shock resistance due to its high tensile strength, high thermal conductivity, low modulus of elasticity at failure, and low coefficient of thermal expansion. It is well known in the art that graphite specimens have been heated to 16,500 degrees centigrade and quenched in water without damage. It can therefore be used without supplementation as the barrier containment material comprising the Repository Disposal Container.

However, the scope of the invention includes permissible supplementation with one or more other, non-graphite containment barriers, which can be internal or external, or internal and external, to the graphite barrier.

Any such external non-graphite containment barrier would mate with, that is, be in close proximity to the external surface of the graphite barrier. Any such internal non-graphite containment barrier would mate with, that is, be in close proximity to the internal surface of the graphite barrier.

Any such non-graphite containment barrier would typically serve one or more of the following purposes: To protect the graphite barrier against damage up to and after emplacement of the vessel in the geologic repository; To facilitate the handling and emplacement of the vessel in the geologic repository by providing an attachment medium for external lifting lugs or transfer mechanisms; To facilitate waste loading by providing an attachment medium for any internal framework, bracing, structures, or fixtures added to the vessel to support the waste in a fixed location; and, To serve as a shorter-term containment barrier (shorter than graphite) against release of the waste into the geologic repository. Non-graphite materials which could serve one or more of these purposes include, but are not limited to, metals, alloys of metals, and plastics. Typically, non-graphite barrier material meeting one or more of these purposes would be 516 carbon steel, carbon steel, stainless steel, Alloy 22, titanium, aluminum, other metals and alloys of metals, and plastics.

In the best mode of the invention, the graphite containment barrier would be sandwiched between 516 carbon steel barriers. For this mode, the vessel would be composed of a 516 carbon steel inner barrier (10), a graphite barrier (11) outside the 516 carbon steel inner barrier, and a second 516 steel barrier (12) outside the graphite barrier.

Within the scope of the invention, the thicknesses of the non-graphite barriers can vary to serve the purpose or purposes for which such barrier is added to the vessel. Such thicknesses typically will vary from about 0.1 centimeters to 100 centimeters.

For the best mode of the invention, the 516 carbon steel barriers would have thicknesses serving all of the typical aforesaid purposes for non-graphite barriers.

Typically, the 516 carbon steel outer barrier would have a thickness between about 0.1 and 30 centimeters. For the best mode of the invention the 516 carbon steel outer barrier (12) would have a thickness about 10 centimeters.

Typically, the 516 carbon steel inner barrier would have a thickness between about 0.1 and 10 centimeters of 516 carbon steel. For the best mode of the invention, the 516 carbon steel inner barrier (10) would have a thickness about 2 centimeters.

For the best mode of the invention, the graphite barrier (11) would have a thickness of about 7 centimeters.

Within the scope of the invention, each open end of any barrier other than graphite should have a sealable lid, preferably made of the same material as the barrier it seals and having approximately the same thickness as the barrier it seals. For the best mode of the invention, the graphite barrier must have a sealable graphite lid about 7 centimeters thick. For the best mode of the invention, there would be a sealable lid for each of the two 516 carbon steel barriers. Each such lid would be made of 516 carbon steel. Such 516 carbon steel lids would be about 2 centimeters thick for the inner barrier and about 10 centimeters thick for the outer barrier.

The Repository Disposal Container is a vessel capable of being employed in a variety of lengths and diameters to accommodate the broadest variety of dimensions of the waste to be contained, for example, uncanistered spent nuclear fuel, canistered spent nuclear fuel, and canistered defense high-level radioactive waste.

The best mode of the invention must also meet government-specified weight restrictions, which impose a practical limit on the overall dimensions. In variations of the invention, the maximum weight is determined by practical limitations of the application and any applicable government regulations.

For the best mode of the invention, the Repository Disposal Container is a cylindrical vessel with an inside diameter of about 145 centimeters, an outside diameter of about 163 centimeters, and an overall length of about 498 centimeters. It is a cylindrical vessel open at the top for loading waste and closed at the bottom. It has an outer barrier (12) of 516 carbon steel, having a thickness of about 10 centimeters. It has a graphite inner barrier (11) (within the 516 carbon steel outer barrier) having a thickness of about 7 centimeters. It has a second inner barrier of 516 carbon steel (10) (within the graphite inner barrier) having a thickness of about 2 centimeters. Each barrier at the open end of the vessel would be sealed after loading the waste. The 516 carbon steel inner barrier would be sealed with a 516 carbon steel lid (15) having a thickness of approximately 2 centimeters. The graphite barrier would be sealed with a graphite lid (14) having a thickness of approximately 7 centimeters. And, the 516 carbon steel outer barrier would be sealed with a 516 carbon steel lid (13) having a thickness of approximately 10 centimeters.

The best mode of the invention has the following features—

1. The 10 centimeters carbon steel casing (outer barrier) provides resistance to mechanical damage during the loading, closure, handling, and retrieval periods.

2. The primary resistance to corrosion is a reactor grade graphite barrier (within the outer barrier) made of graphite.

3. Protection against criticality for radioactive wastes is provided by adding boron carbide to the graphite. The graphite inner barrier in the invention contains sufficient boron carbide (ranging from 0.5% to 5%, preferably 1%) so that the cross section of the boron loaded graphite approximates than that of steel.

4. The peak surface dose rate is maintained within the limits of government regulations (10 CFR 20).

5. The maximum mass of the disposal container will not to exceed the currently specified regulatory weight limit of 75 metric tons for all waste packages.

6. The surface finish on the outer barrier is suitable for surface decontamination as is the case for existing disposal container designs.

7. The oxidation of graphite is minimized by the use of reactor grade graphite of high purity.

8. Hydriding of graphite is negligible.

9. Gas evolution from reactor grade graphite is low.

10. Graphite is insoluble in environmental liquids. The carbon steel does not contain toxic elements, e.g. chromium in Alloy 22, which could be released through corrosion at a rate that could exceed existing federal regulatory release limits.

11. Fire and explosion hazards will be minimized with a graphite inner barrier. encased in steel, which provides a high confidence that the graphite burning potential would be extremely small even in the presence of needed geometry, high temperatures and air flow rates necessary to make graphite burn.

12. The graphite inner barrier has exceptional thermal shock resistance due to its high tensile strength, high thermal conductivity, low modulus of elasticity at failure, and low coefficient of thermal expansion.

13. The graphite will suffer little radiation damage in dimensional and property changes from neutrons at the levels expected for nuclear waste. The potential radiation effects in the graphite barrier will be similar in many respects to those expected for existing metal container designs.

### EXAMPLE 1

Example 1 illustrates a preferred embodiment of the repository disposal container. The repository disposal container is a cylindrical vessel shown in cross section in the drawing. The vessel has is composed of three nested barriers: an outer barrier of 516 carbon steel (12) having a thickness of about 10 centimeters; an inner barrier of graphite (11) within the outer barrier having a thickness of about 7 centimeters and a second inner barrier (10), which is within the first inner barrier, having a thickness of 2 centimeters of carbon steel. Attachable lids, which mate with and seal each 111 barrier, are used to seal the top of the vessel once it contains the waste. The outer barrier lid (13), which is shown attached, is made of 516 carbon steel. The inner barrier of graphite has a lid (14) made of graphite, which is shown attached. The second inner barrier of carbon steel has a lid of carbon steel (13), which is shown attached.

While there has been described herein what is considered to be the preferred and exemplary embodiment of the present invention, other modifications of the invention shall be apparent to those skilled in the art from the teachings herein, and it is, therefore, desired to be secured in the appended claims all such modifications as fall within the true spirit and scope of the invention.

Accordingly, what is desired to be secured by Letters Patent of the United States is the invention as defined and differentiated in the following claims in which we claim:

1. A vessel, open at one or both ends and used for containing wastes in a geologic repository, comprising:
a. a graphite barrier having a thickness between about 0.1 to 300 centimeters, a diameter or width between about 0.1 and 1,000 centimeters, a length between about 0.1 and 1000 centimeters; and,
b. a graphite lid for each open end of the graphite barrier which is capable of sealing the graphite barrier.

2. The vessel of claim 1 further comprising a non-graphite barrier mating with the external surface of the graphite barrier wherein the non-graphite barrier is made of a material selected from a group consisting of metals, alloys of metals, and plastics, and wherein said non-graphite barrier has a thickness between about 0.1 and 100 centimeters; and a lid for each open end of the non-graphite barrier which is capable of sealing the non-graphite barrier.

3. The vessel of claim 2 further comprising a non-graphite barrier mating with the internal surface of the graphite barrier wherein the non-graphite barrier is made of a material selected from a group consisting of metals, alloys of metals, and plastics, and wherein said non-graphite barrier has a thickness between about 0.1 and 100 centimeters; and a lid for each open end of the non-graphite barrier which is capable of sealing the non-graphite barrier.

4. A cylindrical vessel, open at one or both ends and used for containing wastes in a geologic repository, comprising:
a. a graphite barrier having a thickness of about 7 centimeters, a diameter or width of about 145 centimeters, and a length of about 498 centimeters;
b. a graphite lid for each open end of the graphite barrier which is capable of sealing the graphite barrier;
c. a carbon steel barrier, which mates with the external surface of the graphite barrier, and which has a thickness of about 10 centimeters;
d. a carbon steel barrier, which mates with the internal surface of the graphite barrier having a thickness of about 2 centimeters;
e. a carbon steel lid for each open end of the carbon steel barrier mating with the external surface of the graphite barrier, which is capable of sealing said carbon steel barrier; and
f. a carbon steel lid for each open end of the carbon steel barrier mating with the internal surface of the graphite barrier, which is capable of sealing said carbon steel barrier.
